(19) United States
(12) Patent Application Publication
(10) Pub. No.: US 2008/0231604 A1
(43) Pub. Date: Sep. 25, 2008

(54) METHOD FOR EXTENDING THE LIFE OF TOUCH SCREENS

(75) Inventor: Jon Peterson, Everett, WA (US)

Correspondence Address: Stolowitz Ford Cowger, LLP/Cypress, 621 Sw Morrison St., Suite 600, Portland, OR, 97205, US

(73) Assignee: CYPRESS SEMICONDUCTOR CORP., San Jose, CA (US)

(21) Appl. No.: 11/689,929

(22) Filed: Mar. 22, 2007

(51) Int. Cl. G06F 3/041; G06F 3/045

(52) U.S. Cl. 345/173; 345/174

(57) ABSTRACT

In an embodiment, a signature area and virtual keypad, among other display elements, are displayed in more than one location on a touch screen display. As a result, wear and tear may be strategically distributed evenly across the touch screen, instead of isolated to fixed locations, thus increasing the touch screen's useful lifetime. Display degradation is detected in a novel embodiment from physical parameters that are conventionally used for the touch screen's touch sensitivity. By detecting the display degradation according to display location, display elements can be strategically located to enhance the life of the touch screen.

### BACKGROUND

Touch screens generally refer to display overlays which have the ability to display and receive information on the same screen. The effect of such overlays allows a display to be used as an input device, removing the keyboard and/or the mouse as the primary input device for interacting with the display's content. Such displays can be attached to computers or, as terminals, to networks.

Touch screens generally use two types of touch sensing, including 1) resistive sensing and 2) capacitive sensing. Each type has advantages over the other type. For example, the screen clarity of the resistive sensing type may be less than that of the capacitive sensing type, but may be less expensive.

Touch screens are commonly found in retail stores, where they may be used by the customer to enter their signature or personal identification number (PIN) to make a purchase. In this case, the customer will often use a stylus to enter the signature. The touch screen prompts the customer for their signature to be “written” in a specific area, the signature area, of the touch screen demarcated by a graphical box. Every signature entered into the touch screen contributes to wear from rubbing of the stylus tip. A reasonably busy store will have many signature entries, and the rubbing affects of the stylus quickly begin to destroy the signature area of the touch screen where the signature is entered.

In addition to signature entry, a customer may be prompted by the touch screen to enter a PIN, a telephone number, and yes/no answers to a series of purchasing questions. Like the signature, a stylus may be used for the entry of this information. The user's finger tip is also commonly used. In either case, wear on the touch screen becomes noticeable at the fixed locations where the virtual keypad buttons are displayed on the touch screen.

Worn down touch screens contribute to performance degradation. The damaged touch screen has a scratched appearance and, more significantly, a deteriorated responsiveness to input, leading to user frustration. To make matters worse, the deteriorated responsiveness means that the user must press harder on the touch screen, which further accelerates the damage.

The conventional touch screen's signature area and virtual keypad are displayed at a fixed screen location. Thus, all the wear and damage to the touch screen is concentrated at these specific locations, while other areas of the touch screen may be pristine with no damage. Despite the undamaged areas, the touch screen's useful lifespan is determined only by its most damaged areas.

Capacitive sensing touch screens tend to be more durable than their resistive sensing cousins. But even the most durable touch screens eventually succumb to the wear and tear of normal use.

### SUMMARY

Example embodiments relate to methods for extending the life of touch screens. More particularly, example embodiments relate to a method of extending the life of touch screens by varying the position of touch screen elements so that normal wear and tear is not isolated to one or a few locations of the touch screen.

In an embodiment, a signature area and virtual keypad, among other display elements, are displayed in more than one location on a touch screen display. As a result, wear and tear may be strategically distributed evenly across the touch screen, instead of isolated to fixed locations, thus increasing the touch screen's useful lifetime. Display degradation is detected in a novel embodiment from physical parameters that are conventionally used for the touch screen's touch sensitivity. By detecting the display degradation according to display location, display elements can be strategically located to enhance the life of the touch screen.

### BRIEF DESCRIPTION OF THE DRAWINGS

The above and other features and advantages of the invention will become readily apparent by reference to the following detailed description when considered in conjunction with the accompanying drawings, wherein:

FIG. 1 shows a typical touch screen display;

FIG. 2 shows the display elements of FIG. 1 relocated to a different location on the screen, in an embodiment;

FIG. 3 shows the display elements of FIG. 2 having a different orientation and position on the screen, in another embodiment;

FIG. 4 shows the display elements including touch screen advertising, according to an embodiment;

FIG. 5 is a block diagram of the configuration of a touch screen display device, according to an embodiment;

FIG. 6 is a flow chart of an operation of a touch screen display device, according to an embodiment;

FIG. 7 is a flow chart of an operation of a touch screen display device, according to another embodiment; and

FIG. 8 is a flow chart of an operation of a touch screen display device, according to yet another embodiment.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of objects and regions may be exaggerated for clarity.

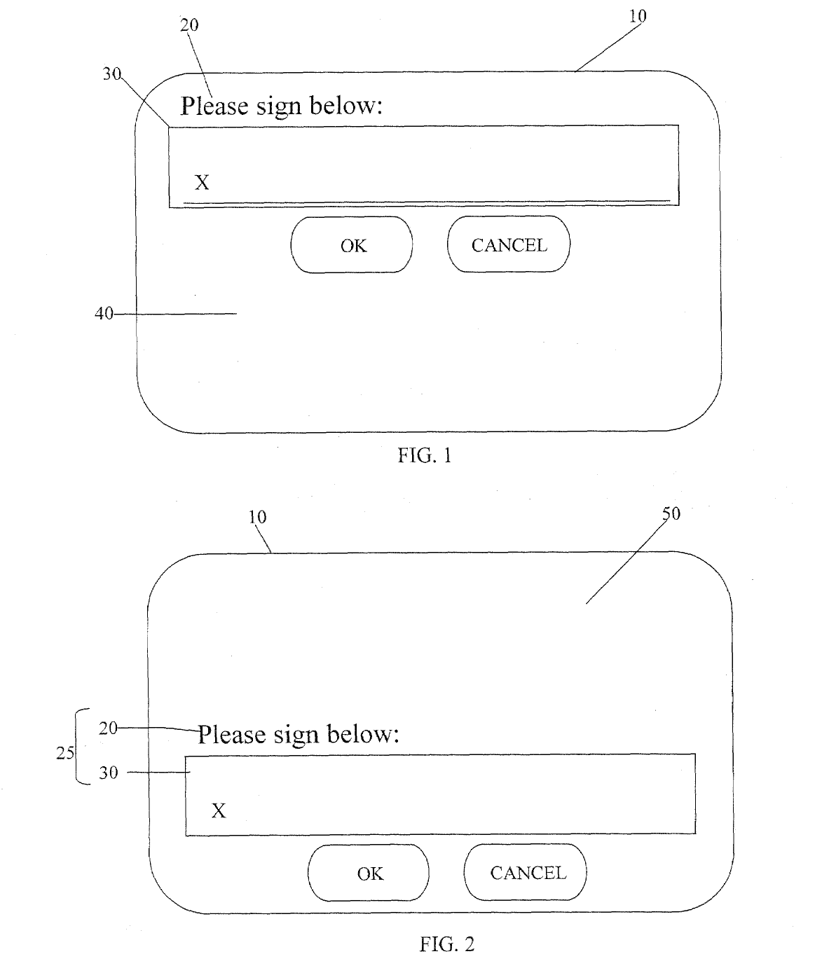

FIG. 1 shows a typical touch screen display 10 displaying elements 20 and 30. A distinction between elements 20 and 30 is that element 20 is informational only, whereas element 30 prompts the touch screen display user for an input, namely a signature. In this disclosure, an informational-only element, such as element 20 is called an output element, since this element represents an output of the touch screen display 10. An input-prompting element, such as element 30 is called an input element, even though a part of this element is a display output, namely the signature box outline or the OK and Cancel buttons. Input element 30 is touch responsive because touching this location of the touch screen display 10 may affect an operation or a step, just as for any input.

Continuing with FIG. 1, a user is instructed by the output element 20 and prompted by the input element 30 to sign his name within the box of input element 30. It is at this time when the user writes his signature with a stylus and then pushes against the touch screen display 10 at either the OK or Cancel buttons of input elements 30. As this process is repeated a large enough number of times, wear and tear damage occurs to the touch screen display 10 at the positions of the input elements 30.

Meanwhile, an unused portion 40 of the touch screen display 10 does not experience wear and tear caused by a user input. Because the life of the touch screen display 10 is determined by the most damaged location, no benefit exists for having undamaged screen portions.

FIG. 2 shows an embodiment that increases the life of the touch screen display 10 by evenly distributing wear and tear to all portions of the display 10.

In this embodiment, a touch screen display device 100 (see FIG. 5) relocates the input and output elements 20 and 30, which hereinafter are collectively referred to as elements 25, from their location in FIG. 1 to the location in FIG. 2. Consequently, the unused portion 40 is eliminated. Instead, a blank portion 50 represents a display location that either has, or will display the elements 25.

In a simple calculation, one can see how the touch screen display 10 may have its life doubled by incorporating the embodiment of FIG. 2. For example, if a touch screen display 10 becomes unusable by the time any single location experiences 10,000 signatures. The conventional touch screen display, which does not move its input element, or signature box, will die after 10,000 signatures. But in the embodiment of FIG. 2, the touch screen display 10 allows for more than one input element 30, or signature, location, each location allowing 10,000 signatures. Thus, two input element locations, for a total of 20,000 signatures, would double the life of the novel touch screen display 10 compared with the conventional touch screen display. Three input element locations, allowing a total of 30,000 signatures, would triple the life of the novel touch screen display 10 compared with the conventional touch screen display, and so on.

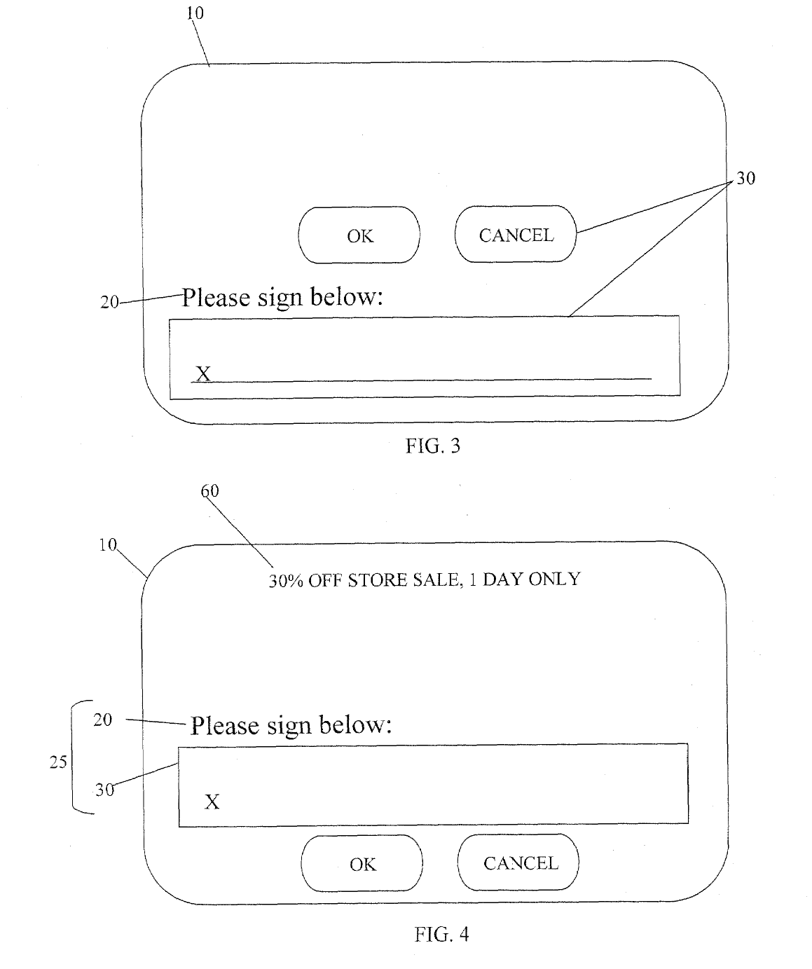

The embodiment of FIG. 3 demonstrates that individual elements may be rearranged with respect to each other while the touch screen display 10 relocates their overall location.

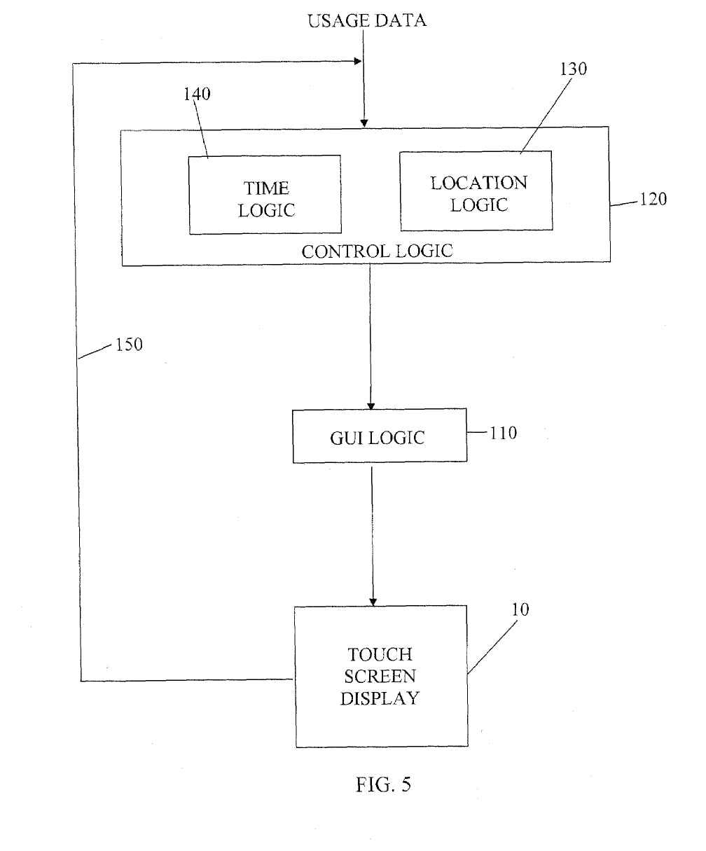

In another embodiment, the blank portion 50 of FIG. 2 may include an advertisement 60 or other informational element, as in the embodiment of FIG. 4. This is called touch screen advertising. Like the relocation and rearranging of elements 25, advertisement 60 may also be thrown in the mix of display elements. Thus, otherwise-wasted blank portion 50 is well utilized for advertising 60 or any other information.

The embodiments described above may be implemented by simply modifying a graphical user interface (GUI) for the touch screen display device 100. The modification may include a software or firmware modification, leaving the remaining touch screen display device 100 physically unchanged. The need to only modify the GUI is advantageous because this type of modification may be readily implemented to the very large number of conventional touch screen displays that are already in use without a large device overhaul or outright replacement.

Another advantage of the fact that only the GUI need be modified is that operational details of the touch screen display 10 may be easily and readily changed. For example, the details of how the elements 25 are relocated can be customized to reflect administrator needs, the administrator being the one that operates the touch screen display device 100. Examples of these details are explained below.

FIG. 5 shows a block diagram of an embodiment of the touch screen display device 100. The touch screen display 10 receives instructions from the GUI logic 110. The GUI logic 110 may include software, hardware, or firmware, as one skilled in the art understands. As mentioned above, it is the GUI logic 110 that may easily be modified to incorporate the novel embodiments described herein.

To administer the novel embodiments, the GUT logic 110 is configured to receive display instructions from control logic 120. Control logic 120 includes a location logic module 130 and a time logic module 140. Control logic 120 is configured to receive usage data, which is described below.

Although shown as separate blocks, the GUI logic 110 and the control logic 120 may be a single entity. In other words, the control logic 120 may merely be an inherent part of the GUI logic 110. This being the case, the control logic 120 and the GUI logic 110 may collectively be referred to as the GUI, which is a familiar term to one skilled in the art. In FIG. 5, these elements are shown separated to simplify an explanation of their respective functions.

In addition, the components shown in FIG. 5 do not constitute an exhaustive list. In other words, the GUI 110 and the control logic 120 may comprise other components.

The GUI logic 110 instructs the touch screen display 10 about display details, such as where elements 25 are to be displayed, and for how long they are to be displayed at a particular location. In turn, the GUI logic instructions may be responsive to the control logic 120.

The control logic 120 may process the usage data that it receives. For example, usage data may include the number of times each location of the touch screen display 10 has been used for a signature input. Usage data may also include physical parameters of the touch screen display 10. Because some physical parameters of the touch screen display 10 change with usage, by normal wear and tear, their change will reflect the touch screen display's usage. More will be said about this later.

The location logic module 130 may include display information, such as the number and location of various positions that can be displayed, the size of the elements 25, and a memory of displayed locations for the elements 25.

The time logic module 140 may include display information regarding time, such as the duration that each element 25 is displayed at a particular location.

Equipped with the location logic module 130 and the time logic module 140, the control logic 120 is enabled to process the usage data to determine the frequency of user input for each display location, the duration that each input and output element is displayed at a particular location, the physical wear and tear experienced by the touch screen display 10, and so on. The GUI logic 110 can then incorporate this information to optimize the touch screen display 10 so that all portions of the display are evenly used, or most effectively used to evenly distribute normal wear and tear throughout the touch screen display 10. The GUI logic 110 may do this by following a set of rules that can intelligently direct the touch screen display device 100 to move the elements 25 at certain times or after a certain number of inputs are performed, for example. This set of rules may be embodied in an endless number of ways, some of which are explained below.

In an embodiment, the display locations of the elements 25 may be based on a clock or calendar. For example, an input element 30 may be displayed at a first location for 4 hours, and then relocated to a second location for 6 hours.

As a side note, the 6 hour duration versus the 4 hour duration in this example may reflect the fact that the first location is worn down more than the second location. Thus, a display practice such as this tends to even out the wear and tear for the entire touch screen display 10.

In another embodiment, the display positions of the elements 25 may be based on a usage number or a frequency of usage for respective locations of the touch screen display 10. For example, if a first location has been used 100 times while a second location has been used 50 times, the input element 30 can be displayed at the second location twice as often as the first location until the usage between the two locations becomes equal.

In another embodiment, the display locations of the elements 25 may be based on a parameter that is chosen by the administrator. For example, an input element 30 may be displayed at a first location for one day, and then displayed at a second location the next day, and so on. The administrator may have a specific reason for his choice, such as for accommodating touch screen advertisements 60 that may change size from one day to the next.

In yet another embodiment, the display locations of the elements 25 may be based on the user choosing a location by touching that location. The user may choose the location because he finds it most convenient, or he wishes to “customize” the touch screen display 10. Though this embodiment may not be optimal for uniformly applying wear and tear to the entire screen, it is an improvement over the conventional art for at least the reason that more than one location of the though screen display 10 is utilized.

In still another embodiment, the display positions of the elements 25 may be based on actual wear and tear of the touch screen display 10. This is possible because the usage data includes a feedback 150 from the touch screen display 10, as shown in FIG. 5. The feedback 150 may include physical parameters of the touch screen display 10, which may include a resistivity or a capacitance of a specific location of the touch screen display 10. These parameters are readily available because they are already utilized by the conventional touch screen display to be touch responsive according to screen location. One skilled in the art can adapt these physical parameters to the novel embodiments described herein.

Continuing with the last-described embodiment, the GUI logic 110 may optimally determine where to display the input element 30 on the touch screen display screen 10. The GUI logic 110 may have the entire screen mapped with respect to levels of wear. The GUI logic 110 may then display input element 30 at the location of least wear.

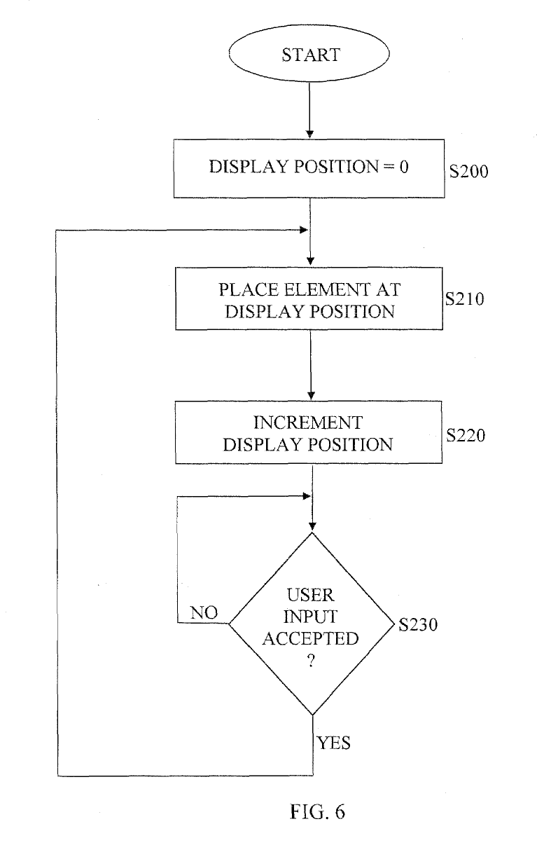

FIG. 6 is an operational flow chart of the GUI logic 110 according to an embodiment. To begin, a display position variable is initialized in step S200. In step S210 the display position variable is used as a location index for displaying an element 25 at a display location represented by the location index. Next, the display position variable is incremented in step S220. In step S230, a user enters an input at the display location. The process then repeats, but the incremented display position variable causes the display location to change before the next user entry.

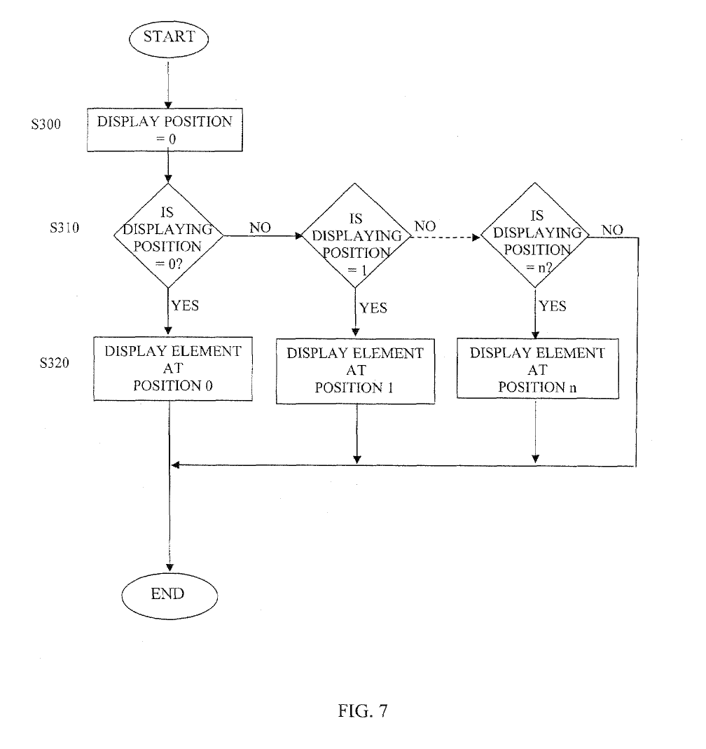

FIG. 7 is an operational flow chart of the GUI logic 110 according to another embodiment. To begin, the display position variable is initialized to some value in step S300. In step S310, a decision process determines the value of the display position variable. In step S320, the element 25 is displayed at the display position represented by the display position variable.

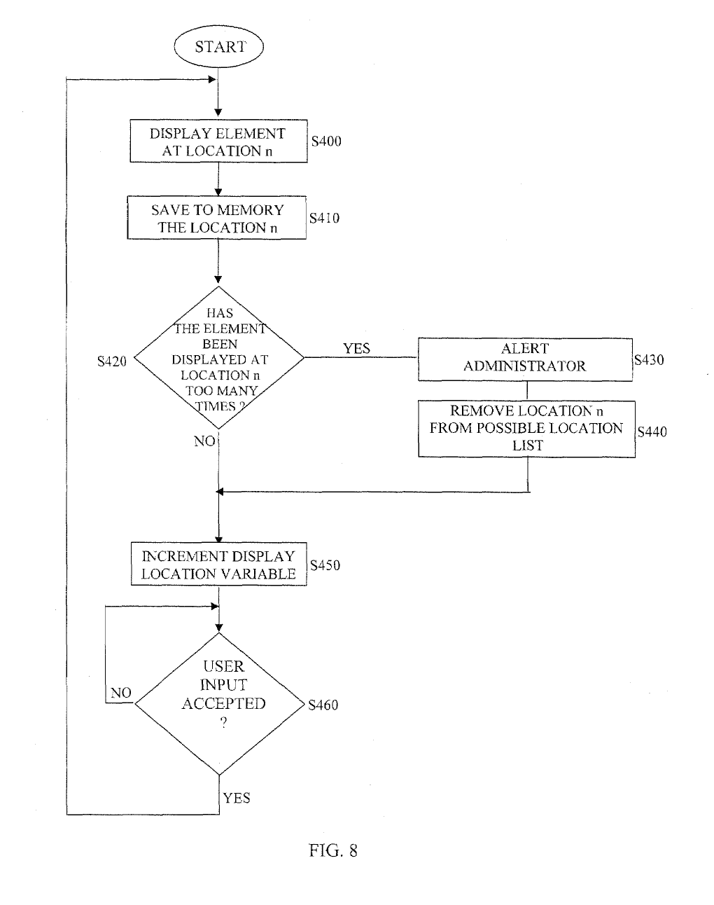

FIG. 8 is an operational flow chart of the GUI logic 110 according to yet another embodiment. In step S400, element 25 is displayed at a location n. In step S410, the location n of the displayed element is saved in a memory. In step S420, a determination is made as to whether or not the element 25 has been displayed at the location n too many times. Here, a number of times considered to be too many may be defined by measured data of characteristics of the touch screen display 10, for example. In other words, knowledge of a rate of degradation of the touch screen display 10 leads to a determination of what number of display times at a specific location may be considered to be too many.

The number of times considered to be too many may also be determined by utilizing the usage data that includes the touch screen display parameters such as the resistivity and capacitance, as described above.

If the number of display times at the location n is not too many, then the display location variable n is incremented in step S450 so that a subsequent user input will be at another location.

If the number of display times at the location is too many, then the administrator is notified, as in step S430. Here, a notification may simply include a recording of this event into a memory for future analysis.

Next, in this embodiment, the display location n, which has been used too many times, is removed as an option for all subsequent uses, in step S440.

As described in the embodiments above, relocating display elements to various locations of a touch screen display may greatly prolong the life of the touch screen display. The foregoing is illustrative of some embodiments of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of controlling a touch screen display used as an input device by a user, the method comprising:
displaying a touch screen element on the touch screen at a first location; and
relocating the touch screen element so that the touch screen element is displayed at a second location on the touch screen.

2. The method of claim 1, further comprising:
determining a display time during which the touch screen element is displayed at the first location.

3. The method of claim 1, wherein the touch screen element is touch responsive.

4. The method of claim 1, wherein relocating the touch screen element is responsive to a usage frequency at the first location.

5. The method of claim 1, wherein relocating the touch screen element is responsive to a clock or a calendar.

6. The method of claim 1, wherein relocating the touch screen element is responsive to an administrator-chosen parameter.

7. The method of claim 1, wherein relocating the touch screen element is responsive to the user choosing the second location.

8. The method of claim 1, wherein relocating the touch screen element is responsive to a touch screen degradation.

9. The method of claim 8, further comprising:
detecting a change in electrical characteristics of the touch screen; and
determining the touch screen degradation by considering the detected change in electrical characteristics.

10. The method of claim 1, wherein the touch screen element includes touch screen advertising.

11. The method of claim 1, wherein the touch screen is a resistive touch screen that uses resistive sensing to detect a screen touch location.

12. The method of claim 1, wherein the touch screen is a capacitive touch screen that uses capacitive sensing to detect a screen touch location.

13. The method of claim 1, further comprising
additionally relocating the touch screen element so that the touch screen element is displayed at subsequent locations on the touch screen after being displayed at the second location.

14. The method of claim 1, further comprising:
determining an amount of usage of the touch screen from the user contacting the touch screen, wherein
relocating the touch screen element is responsive to determining the amount of usage, so that the touch screen element is displayed at the second location on the touch screen.

15. The method of claim 14, wherein determining the amount of usage comprises detecting a change in electrical characteristics of the touch screen.

16. The method of claim 14, wherein determining the amount of usage comprises:
analyzing test data to determine a rate of degradation of the touch screen; and
measuring an elapsed time that the touch screen element is displayed at the first location, or measuring a number of times that the user contacts the touch screen at the first location.

17. A touch screen display device used as an input device by a user, comprising:
a touch screen; and
logic to display a touch screen element on the touch screen at a first location during a display time, and
alter the display time, relocate the touch screen element so that the touch screen element is displayed at a second location on the touch screen.

18. The display device of claim 17, wherein the display time is responsive to a number of times the user contacts the touch screen at the first location.

19. The display device of claim 17, wherein the second location is determined responsive to a number of times the user contacts the touch screen.

20. An article comprising a storage medium, the storage medium having stored instructions, that, when executed by a machine result in:
displaying a touch screen display element on the touch screen at a first location, wherein the touch screen display element is touch responsive; and
relocating the touch screen display element so that the touch screen display element is displayed at a second location on the touch screen.

21. The method of claim 20, wherein relocating the touch screen display element is responsive to a usage frequency at the first location.

22. The method of claim 20, further comprising:
determining an amount of usage of the touch screen from the user contacting the touch screen, wherein
relocating the touch screen display element is responsive to determining the amount of usage, so that the touch screen display element is displayed at the second location on the touch screen.

23. The method of claim 22, wherein determining the amount of usage comprises detecting a change in electrical characteristics of the touch screen.

24. The method of claim 22, wherein determining the amount of usage comprises:
analyzing test data to determine a rate of degradation of the touch screen; and
measuring an elapsed time that the touch screen display element is displayed at the first location, or measuring a number of times that the user contacts the touch screen at the first location.
